(19) United States
(12) Patent Application Publication
(10) Pub. No.: US 2017/0198115 A1
(43) Pub. Date: Jul. 13, 2017

(54) Calcining Paste Composition and Uses Thereof

(71) Applicant: Soken Chemical & Engineering Co., Ltd., Tokyo (JP)

(72) Inventors: Hiroto Matsumoto, Sayama-shi (JP); Shinsuke Yabunaka, Sayama-shi (JP); Shu-ichi Goto, Sayama-shi (JP)

(21) Appl. No.: 15/314,665

(22) PCT Filed: May 11, 2015
(86) PCT No.: PCT/JP2015/063427

§ 371 Date: Nov. 29, 2016

(30) Foreign Application Priority Data
May 30, 2014 (JP) 2014-113186

(51) Int. Cl. C08K 3/08; H01G 4/12; H01G 4/30; C08F 220/14; C08K 3/00

(52) U.S. Cl. CPC C08K 3/08; C08F 220/14; C08K 3/0033; H01G 4/30; H01G 4/12; C08K 2003/0862

(57) ABSTRACT

Provided is a calcining paste composition having excellent printability and good calcining property while having appropriate viscosity. The calcining paste composition includes a copolymer (A) obtained by copolymerizing a monomer mixture containing a monomer (a-1) represented by the formula (I) in an amount of 10 to 80% by mass and a monomer (a-2) represented by the formula (II) in an amount of 20 to 90% by mass, said copolymer (A) having Mw of 2.01×10⁵ to 1.5×10⁶.

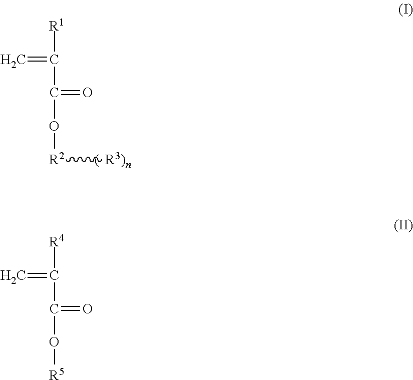

TECHNICAL FIELD

The present invention relates to a calcining paste composition and uses thereof.

### BACKGROUND ART

A calcining paste composition is a composition containing an inorganic powder (filler), such as metal powder, metal oxide powder, ceramic powder, glass powder or fluorescent powder, a binder resin and a solvent, etc., and is a composition used for forming a pattern made of the inorganic powder by applying the composition to a base and then calcining the composition to thermally decompose the binder resin.

For example, a conductive paste composition containing conductive powder is used for formation of a circuit, production of a condenser, etc. A ceramic paste composition containing ceramic powder or a glass paste composition containing glass powder is used for a dielectric layer of a plasma display panel (PDP), a dielectric layer of a multi-layer ceramic condenser (MLCC), a fluorescent display tube or the like. A paste composition containing indium tin oxide (ITO) is used for a transparent electrode material for forming PDP, a liquid crystal display panel (LCD), a touch panel, a circuit of a solar panel drive unit, etc. In addition, a paste composition containing a fluorescent substance is used for an inorganic electroluminescent (EL) element, PDP, FED, etc., and a paste composition containing silver is used for a solar cell, light emitting diode (LED), etc.

For the application of this calcining paste composition to a base, a coating method using, for example, screen printing, die coating, doctor blade printing, roll coating, off set printing, gravure printing, flexographic printing, inkjet printing or disperser printing, a casting method for forming a sheet or another method is used.

Accordingly, the binder resin is required to have applicability to a base by the above coating method and ability to disperse the inorganic powder. In the past, ethyl cellulose and polyvinyl butyral excellent in these abilities have been used as binder resins (see, for example, patent literature 1).

Moreover, the binder resin used as above is nonconductive, and therefore, if a residue of a carbon component is left after calcining, there occurs a problem such that the residue hinders performance of an electronic product on which a pattern made of a conductive inorganic powder in the paste composition has been formed. On this account, the binder resin is desired to be excellent in the property (calcining property) that the binder resin is thermally decomposed by calcining without leaving any residue of a carbon component. However, the aforesaid ethyl cellulose and polyvinyl butyral do not have sufficient thermal decomposability, and their calcining property is not good.

Then, an acrylic resin having good calcining property is being used as a binder resin of a calcining paste composition. In the acrylic resin, however, an interaction between (meth)acryloyl groups in a polymer chain and among polymer chains takes place because of deviation of electric charge at the carbonyl site of the (meth)acryloyl group, and hence, the polymer chains exist in the entangled state in the calcining paste composition. On that account, stringing of the calcining paste composition takes place during the coating process, and there occurs a problem that the smoothness of the surface of the coating film is impaired.

### CITATION LIST

### Patent Literature

Patent literature 1: Japanese Patent Laid-Open Publication No. 2012-129181

### SUMMARY OF INVENTION

### Technical Problem

It is an object of the present invention to provide a calcining paste composition having excellent printability and good calcining property while having appropriate viscosity.

### Solution to Problem

The present invention is, for example, any of the following [1] to [12].

[1] A calcining paste composition comprising a copolymer (A) obtained by copolymerizing a monomer mixture containing a monomer (a-1) represented by the following general formula (I) in an amount of 10 to 80% by mass and a monomer (a-2) represented by the following general formula (II) in an amount of 20 to 90% by mass (with the proviso that the total amount of the monomer mixture is 100% by mass), said copolymer (A) having a weight-average molecular weight of 2.01×10⁵ to 1.5×10⁶,

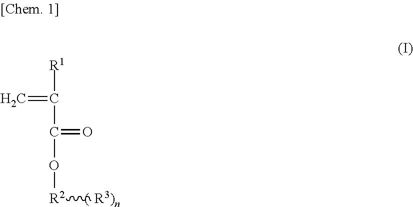

wherein R¹ represents a hydrogen atom or a methyl group, R² represents a branched hydrocarbon group, a straight-chain hydrocarbon group, a group having a cyclic structure or a single bond, R³ represents a group selected from the group consisting of a hydroxyl group, a carboxyl group, an amino group, an amide group, an acetoacetoxy group, an acid anhydride group, a sulfonic acid group, a phosphoric acid group, a thiol group and a heterocyclic group, n represents an integer of 1 to 6, when n is 2 or greater, R³s may be the same as or different from each other, when R² is a single bond or a straight-chain hydrocarbon group, R³ is a heterocyclic group, and R² and R³ are bonded to each other by one or two bonding hands,

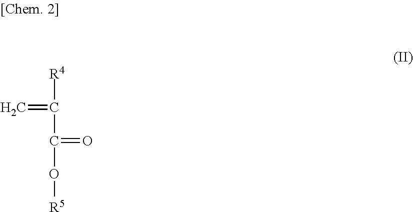

wherein R⁴ represents a hydrogen atom or a methyl group, and R⁵ represents a branched alkyl group or a group having a cyclic structure.

[2] The calcining paste composition as stated in [1], wherein the SP value of the copolymer (A) is 7 to 10.

[3] The calcining paste composition as stated in [1] or [2], comprising:

the copolymer (A),

a solvent (B), and

an inorganic powder (C).

[4] The calcining paste composition as stated in [3], wherein the copolymer (A) and the solvent (B) satisfy a relationship of the following formula (III):

|(SP value of the copolymer (A))−(SP value of the solvent (B))|<2 (III)

[5] The calcining paste composition as stated in [3] or [4], further comprising a dispersing agent (D).

[6] The calcining paste composition as stated in [5], containing the copolymer (A) in an amount of 1 to 20% by mass, containing the solvent (B) in an amount of 20 to 70% by mass, containing the inorganic powder (C) in an amount of 20 to 70% by mass and containing the dispersing agent (D) in an amount of 0.01 to 5% by mass, each amount being based on 100% by mass of the calcining paste composition.

[7] The calcining paste composition as stated in any one of [1] to [6], being for screen printing.

[8] A green sheet comprising the calcining paste composition as stated in any one of [3] to [6].

[9] A laminate of the calcining paste composition as stated in any one of [3] to [6] and a green sheet.

[10] A multi-layer ceramic condenser produced by using the calcining paste composition as stated in any one of [3] to [6].

[11] A production process for a calcined body, comprising:

a step of applying the calcining paste composition as stated in any one of [1] to [6] to a base,

a step of drying the applied calcining paste composition, and

a step of calcining a laminate of the dried calcining paste composition and the base.

[12] A calcined body obtained by the production process for a calcined body as stated in [11].

### Advantageous Effects of Invention

The calcining paste composition of the present invention comes to have good fluidity by applying a stress such as stirring to the composition in the coating process while the composition has appropriate viscosity, so that the composition is excellent in printability, and a coating film having a smooth surface can be obtained. Further, the calcining paste composition also has good calcining property.

### DESCRIPTION OF EMBODIMENTS

The present invention will be specifically described hereinafter.

In the present specification, the term “(meth)acryloyl” is used to indicate both or one of acryloyl and methacryloyl, the term “(meth)acrylate” is used to indicate both or one of acrylate and methacrylate, and the term “(meth)acrylic” is used to indicate both or one of acrylic and methacrylic.

The calcining paste composition of the present invention is characterized by comprising a copolymer (A) obtained by copolymerizing a monomer mixture containing a monomer (a-1) represented by the following general formula (I) in an amount of 10 to 80% by mass and a monomer (a-2) represented by the following general formula (II) in an amount of 20 to 90% by mass (with the proviso that the total amount of the monomer mixture is 100% by mass), said copolymer (A) having a weight-average molecular weight of 2.01×10⁵ to 1.5×10⁶.

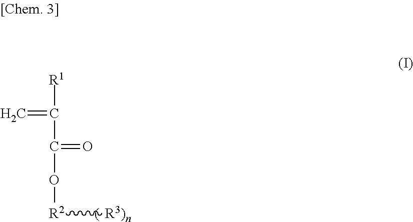

wherein R¹ represents a hydrogen atom or a methyl group, R² represents a branched hydrocarbon group, a straight-chain hydrocarbon group, a group having a cyclic structure or a single bond, R³ represents a group selected from the group consisting of a hydroxyl group, a carboxyl group, an amino group, an amide group, an acetoacetoxy group, an acid anhydride group, a sulfonic acid group, a phosphoric acid group, a thiol group and a heterocyclic group, n represents an integer of 1 to 6, when n is 2 or greater, R³s may be the same as or different from each other, when R² is a single bond or a straight-chain hydrocarbon group, R³ is a heterocyclic group, and R² and R³ are bonded to each other by one or two bonding hands,

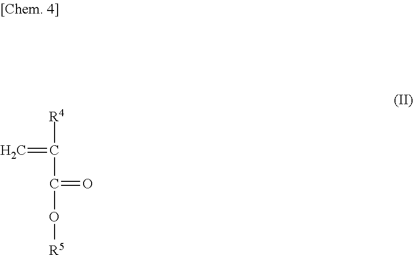

wherein R⁴ represents a hydrogen atom or a methyl group, and R⁵ represents a branched alkyl group or a group having a cyclic structure.

1. Copolymer (A)

(1) Monomer (a-1)

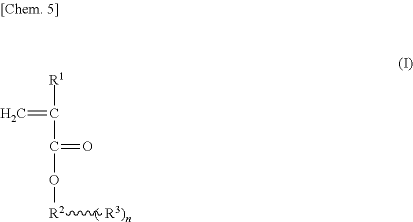

wherein R¹ represents a hydrogen atom or a methyl group, R² represents a branched hydrocarbon group, a straight-chain hydrocarbon group, a group having a cyclic structure or a single bond, R³ represents a group selected from the group consisting of a hydroxyl group, a carboxyl group, an amino group, an amide group, an acetoacetoxy group, an acid anhydride group, a sulfonic acid group, a phosphoric acid group, a thiol group and a heterocyclic group, n represents an integer of 1 to 6, when n is 2 or greater, R³s may be the same as or different from each other, when R² is a single bond or a straight-chain hydrocarbon group, R³ is a heterocyclic group, and R² and R³ are bonded to each other by one or two bonding hands.

In the general formula (I), R¹ represents a hydrogen atom or a methyl group

In the general formula (I), R² represents a branched hydrocarbon group, a straight-chain hydrocarbon group, a group having a cyclic structure or a single bond.

As the branched hydrocarbon group, there can be mentioned a branched alkylene group or a group obtained by removing hydrogen from a branched alkylene group in such a manner that the resulting group becomes trivalent to hexavalent, preferably trivalent to tetravalent. The group obtained by removing hydrogen from a branched alkylene group in such a manner that the resulting group becomes trivalent to hexavalent refers to, in for example a trivalent case, a group wherein one hydrogen has been removed from a branched alkylene group and its position has become substitutable with an arbitrary group, while a branched alkylene group is divalent inherently. Examples of the branched alkylene groups include isobutylene group, sec-butylene group, tert-butylene group, 2-ethylhexylene group, neopentylene group, isooctylene group and 2,2,4-trimethylpentylene group. The number of carbon atoms of the branched hydrocarbon group is preferably 4 to 18, more preferably 4 to 10, from the viewpoint of obtaining a viscosity suitable for formation of a coating film.

As the straight-chain hydrocarbon group, there can be mentioned a straight chain alkylene group or a group obtained by removing hydrogen from a straight-chain alkylene group in such a manner that the resulting group becomes trivalent to hexavalent, preferably trivalent to tetravalent. Examples of the straight-chain alkylene groups include methylene group, ethylene group, propylene group, butylene group, pentylene group, hexylene group, heptylene group, octylene group, decylene group and laurylene group. The number of carbon atoms of the straight-chain hydrocarbon group is preferably 1 to 4, more preferably 1 or 2, from the viewpoint of obtaining a viscosity suitable for formation of a coating film.

When R² is a straight-chain hydrocarbon group, R³ is a heterocyclic group.

As the group having a cyclic structure, a cyclic hydrocarbon group or a cyclic hydrocarbon group having a chain part can be mentioned. As the cyclic hydrocarbon group, there can be mentioned a cyclic alkylene group, a group obtained by removing hydrogen from a cyclic alkylene group in such a manner that the resulting group becomes trivalent to hexavalent, preferably trivalent to tetravalent, or an aromatic group. Examples of the cyclic alkylene groups include groups obtained by removing one hydrogen from each of cyclobutyl group, cyclopentyl group, cyclohexyl group, cycloheptyl group, cyclooctyl group, tricyclodecyl group, bicyclooctyl group, tricyclododecyl group, isobornyl group, adamantly group, tetracyclododecyl group, dicyclopentanyl group and dimethylcyclohexyl group. Examples of the aromatic groups include groups obtained by removing one hydrogen from each of phenyl group, naphthyl group, anthryl group, phenanthryl group, tolyl group, xylyl group and mesityl group.

The chain part of the cyclic hydrocarbon group having a chain part is at least one kind selected from the group consisting of a carbonyl group, an oxy group and an alkylene group of 1 to 12 carbon atoms, preferably 1 to 6 carbon atoms. Examples of the cyclic hydrocarbon groups of the cyclic hydrocarbon groups having a chain part include the same groups as previously described. As the cyclic hydrocarbon group having a chain part, an ethyleneoxycarbonylcyclohexylene group or the like can be mentioned.

The number of carbon atoms of the cyclic hydrocarbon group is preferably 4 to 18, more preferably 4 to 10, from the viewpoint of obtaining a viscosity suitable for formation of a coating film.

When R² is a single bond, R³ is a heterocyclic group.

From the viewpoint of solubility in a solvent, R² is preferably a branched hydrocarbon group, a straight-chain hydrocarbon group, a cyclic alkylene group, a cyclic alkylene group having a chain part, a group obtained by removing hydrogen from a cyclic alkylene group in such a manner that the resulting group becomes trivalent to hexavalent, a group having a chain part and obtained by removing hydrogen from a cyclic alkylene group in such a manner that the resulting group becomes trivalent to tetravalent, or a single bond, among the aforesaid branched hydrocarbon groups, straight-chain hydrocarbon groups, groups having a cyclic structure and single bond. From the viewpoint of obtaining a value capable of forming a coating film as the viscosity of the calcining paste composition, R² is more preferably a branched hydrocarbon group of 4 to 10 carbon atoms, a cyclic alkylene group, a cyclic alkylene group having a chain part, a group obtained by removing hydrogen from a cyclic alkylene group in such a manner that the resulting group becomes trivalent to hexavalent, or a group having a chain part and obtained by removing hydrogen from a cyclic alkylene group in such a manner that the resulting group becomes trivalent to tetravalent, said each cyclic alkylene having 4 to 12 carbon atoms, and R² is still more preferably a branched hydrocarbon group of 4 to 10 carbon atoms.

The molecular weight of R² is preferably 30 to 180, more preferably 50 to 160, excluding the case where R² is a single bond or a straight-chain hydrocarbon group.

In the general formula (I), R³ represents a group selected from the group consisting of a hydroxyl group, a carboxyl group, an amino group, an amide group, an acetoacetoxy group, an acid anhydride group, a sulfonic acid group, a phosphoric acid group, a thiol group and a heterocyclic group. As the heterocyclic group, an oxirane group or an oxolane group is preferable. Of these functional groups, preferable are hydroxyl group, carboxyl group, amino group, acid anhydride group, oxirane group and oxolane group, and more preferable are hydroxyl group, amino group, acid anhydride group, oxirane group and oxolane group. Here, the heterocyclic groups include condensed rings such as 3,4-epoxycyclohexane group.

n represents an integer of 1 to 6, and when n is 2 or greater, R³s may be the same as or different from each other. n is preferably an integer of 1 to 3, and is more preferably 1 or 2. When the valence of R² is 2, n is 1.

As described later, R² is thought to play a role of a steric hindrance group excluding the case where R² is a single bond or a straight-chain hydrocarbon group, and R³ is thought to play a role to form an intermolecular force, while the heterocyclic group is thought to play both of the roles. On that account, when R³ is a heterocyclic group, R² does not need to be a steric hindrance group, and therefore, when R³ is a heterocyclic group, R² may be a single bond or a straight-chain hydrocarbon group.

R² and R³ are bonded to each other by one or two bonding hands. Many of the examples of R³ given above are each bonded to R² by one bonding hand. However, when R³ is, for example, an acid anhydride group, the acid anhydride group has two ends, so that this group is bonded to R² by two bonding hands. When the valence of R² is 2, the number of bonding hands is 1.

Examples of the monomers (a-1) include (meth) acrylic acid esters, such as 2-hydroxyisobutyl (meth)acrylate, 2-hydroxyisopropyl (meth)acrylate, 2,2,4-trimethyl-3-hydroxypentyl (meth)acrylate, cyclohexanedimethanol mono(meth)acrylate, 2-(meth)acryloyloxyethylhexahydrophthalic acid, pentamethylpiperidyl (meth) acrylate, tetrahydrofurfuryl (meth) acrylate, γ-butyrolactone (meth) acrylate, 2,2-dimethyl-3-hydroxypropyl (meth)acryalte, hydroxycyclohexyl (meth)acrylate, 4-(meth)acryloyloxy-2,2,6,6-tetramethylpiperidine, (meth)acrylic acid [(3, 4-epoxycylohexan)-1-yl]methyl, and a reaction product of dicyclopentenyl (meth)acrylate with maleic anhydride. These monomers (a-1) can be used singly or as a mixture of two or more kinds.

In 100% by mass of the monomer mixture, the proportion of the monomer (a-1) is 10 to 80% by mass, preferably 10 to 70% by mass, more preferably 30 to 60% by mass. When the proportion of the monomer (a-1) is in the above range, stringing can be inhibited, and besides, because of good thixotropic property, printability is good, and calcining property is not lowered.

(2) Monomer (a-2)

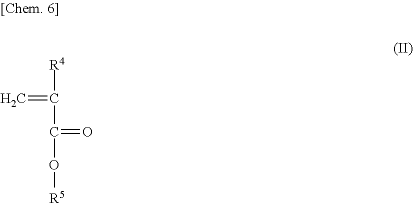

wherein R⁴ represents a hydrogen atom or a methyl group, and R⁵ represents a branched alkyl group or a group having a cyclic structure.

In the formula (II), R⁴ represents a hydrogen atom or a methyl group.

In the general formula (II), R⁵ is a branched alkyl group or a group having a cyclic structure.

In the monomers (a-2), the monomers (a-1) are not included.

Examples of the branched alkyl groups include isobutyl group, sec-butyl group, tert-butyl group, 2-ethylhexyl group, neopentyl group and isooctyl group. The number of carbon atoms of the branched alkyl group is preferably 4 to 18, more preferably 4 to 10, from the viewpoint of obtaining a viscosity suitable for formation of a coating film.

As the group having a cyclic structure, a cyclic alkyl group, a cyclic alkyl group having a chain part, an aromatic group or an aromatic group having a chain part can be mentioned. Examples of the cyclic alkyl groups include cyclobutyl group, cyclopentyl group, cyclohexyl group, cycloheptyl group, cyclooctyl group, tricyclodecyl group, bicyclooctyl group, tricyclododecyl group, isobornyl group, adamantly group, tetracyclododecyl group and dicyclopentanyl group. Examples of the aromatic groups include phenyl group, naphthyl group, anthryl group, phenanthryl group, tolyl group, xylyl group and mesityl group. The chain part of the cyclic alkyl group having a chain part and the aromatic group having a chain part is, for example, an alkylene group of 1 to 12 carbon atoms, preferably 1 to 6 carbon atoms. The number of carbon atoms of the cyclic alkyl group is preferably 4 to 18, more preferably 4 to 10, from the viewpoint of obtaining a viscosity suitable for formation of a coating film. The number of carbon atoms of the aromatic group is preferably 6 to 18, more preferably 6 to 10, from the viewpoint of solubility in a solvent.

From the viewpoint of solubility in a solvent, R⁵ is preferably a branched alkyl group, a cyclic alkyl group or a cyclic alkyl group having a chain part, among the aforesaid branched alkyl groups and the groups having a cyclic structure, and from the viewpoint of obtaining a value capable of forming a coating film as the viscosity of the calcining paste composition, R⁵ is more preferably a branched alkyl group of 4 to 10 carbon atoms, a cyclic alkyl group or a cyclic alkyl group having a chain part, each of said cyclic alkyl groups having 4 to 12 carbon atoms, and R⁵ is still more preferably a branched alkyl group of 4 to 10 carbon atoms.

The molecular weight of R⁵ is preferably 30 to 180, more preferably 50 to 160.

Specific examples of the monomers (a-2) include tert-butyl (meth)acrylate, cyclohexyl (meth)acrylate, isobornyl (meth)acrylate, dicyclopentanyl (meth)acrylate, adamantly (meth)acrylate, isobutyl (meth) acrylate, neopentyl (meth) acrylate, 2-ethylhexyl (meth)acrylate and isooctyl (meth)acrylate. These may be used singly, or may be used in combination of two or more kinds. Of these, preferable are tert-butyl (meth)acrylate, cyclohexyl (meth)acrylate, isobornyl (meth)acrylate, isobutyl (meth)acrylate and neopentyl (meth)acrylate, from the viewpoint of viscosity and calcining property of the calcining paste composition.

In 100% by mass of the monomer mixture, the proportion of the monomer (a-2) is 20 to 90% by mass, preferably 30 to 90% by mass, more preferably 40 to 70% by mass. When the proportion of the monomer (a-2) is in the above range, stringing can be inhibited, and besides, calcining property is good, and solvent solubility is good.

(3) Monomer (a-3)

For the copolymer (A) of the present invention, a monomer mixture further containing a monomer (a-3) in addition to the monomer (a-1) and the monomer (a-2) may be copolymerized.

Specific examples of the monomers (a-3) include methyl (meth)acrylate, ethyl (meth)acrylate, n-butyl (meth)acrylate, lauryl (meth)acrylate, styrene, a vinyl compound, (meth)acrylic acid, maleic anhydride, 2-methacryloyloxyethylsuccinic acid, 2-(meth)acryloyloxyethylphthalic acid, acetoacetoxy (meth) acrylate, N,N-dimethylaminoethyl (meth)acrylate, N,N-diethylaminoethyl (meth)acrylate, (meth)acrylamide, 2-(meth)acryloyloxyethyl acid phosphate, 2-(meth)acrylamido-2-methylpropanesulfonic acid, and (meth)acrylic acid esters, e.g., hydroxyl group-containing (meth)acrylic acid esters, such as 2-hydroxyethyl methacryalte, 2-hydroxy-n-propyl (meth)acrylate, 3-hydroxy-n-propyl (meth)acrylate, 3-hydroxybutyl (meth)acrylate, 4-hydroxybutyl (meth)acrylate, polyethylene glycol mono(meth)acrylate and polypropylene glycol mono(meth)acrylate. Of these, preferable are (meth)acrylic acid, acetoacetoxy (meth)acrylate, N,N-dimethylaminoethyl (meth)acrylate, 2-hydroxyethyl methacrylate, etc. These monomers (a-3) can be used singly or as a mixture of two or more kinds.

In 100% by mass of the monomer mixture, the proportion of the monomer (a-3) is 0 to 50% by mass, and in its use preferably 10 to 40% by mass, more preferably 10 to 30% by mass. When the proportion of the monomer (a-3) is in the above range, solvent solubility can be adjusted.

(4) Production Process for Copolymer (A)

Although the polymerization method to produce the copolymer (A) of the present invention is not specifically restricted, it is preferable to usually use solution polymerization. The solution polymerization is generally carried out by introducing prescribed organic solvent, monomers and polymerization initiator into a polymerization vessel and allowing the monomers to undergo heating reaction at an appropriate polymerization temperature for several hours in a stream of an inert gas such as nitrogen while stirring. In this case, at least a part of the organic solvent, the monomers, and the polymerization initiator and/or a chain transfer agent may be added successively.

Examples of the organic solvents for polymerization include aromatic hydrocarbons, such as benzene, toluene, ethylbenzene, n-propylbenzene, t-butylbenzene, o-xylene, m-xylene, p-xylene, tetralin, decalin and aromatic naphtha; aliphatic or alicyclic hydrocarbons, such as n-hexane, n-heptane, n-octane, i-octane, n-decane, dipentene, petroleum spirit, petroleum naphtha and turpentine oil; esters, such as alkyl acetate (here, alkyl is, for example, methyl, ethyl, propyl, butyl or pentyl; the same shall apply hereinafter) and methyl benzoate; derivatives of ethylene glycol, such as monoacetate, diacetate, alkyl ether acetate, (e.g., diethylene glycol monobutyl ether acetate), monoalkyl ether and dialkyl ether of ethylene glycol or diethylene glycol; propylene glycol derivatives, such as monoacetate, diacetate, alkyl ether acetate, monoalkyl ether (e.g., tripropylene glycol monobutyl ether) or dialkyl ether of any one glycol of propylene glycol, dipropylene ethylene glycol and tripropylene glycol; ketones, such as acetone, methyl ethyl ketone, methyl i-butyl ketone, isophorone, cyclohexanone and methylcyclohexanone; and texanol (2,2,4-trimethylpentane-1,3-diol monoisobutyrate). These organic solvents can be used singly or as a mixture of two or more kinds. As the organic solvent for polymerization, a solvent having a high boiling point is preferable, and specifically, a solvent having a boiling point of 50 to 300° C. is more preferable.

Examples of the polymerization initiators include organic peroxides, such as benzoyl peroxide, lauroyl peroxide, caproyl peroxide, di-t-butyl peroxide, di-i-propyl peroxydicarbonate, di-2-ethylhexyl peroxydicarbonate, t-butyl peroxypivalate; and azo compounds, such as 2,2′-azobis-i-butyronitile, 2,2′-azobis-2,4-dimethylvaleronitrile and 2,2′-azobis-4-methoxy-2,4-dimethylvaleronitrile. These polymerization initiators can be used singly or in combination.

The amount of the polymerization initiator used is generally in the range of 0.01 to 5 parts by mass, preferably 0.02 to 2 parts by mass, based on 100 parts by mass of the total amount of the monomer mixture.

The polymerization temperature is preferably 40 to 180° C. When the polymerization temperature is in the above range, not only is a satisfactory reaction rate obtained but also depolymerization due to a too high temperature does not occur.

The time for carrying out the reaction at the above polymerization temperature is preferably 4 to 16 hours. When the reaction time is in the above range, the reaction can be allowed to completely proceed.

In order to allow the weight-average molecular weight of the copolymer to be within the range of the present invention, it is also preferable that the polymerization initiator is not only added in the initial stage of the polymerization but also further added after the polymerization proceeds to a certain extent. In that case, the amount of the polymerization initiator used is preferably within the above range as a total amount of all of the polymerization initiator added.

After the reaction is carried out, the reaction mixture is cooled down to room temperature. Then, a nonpolar solvent such as hexane is used to precipitate a copolymer. The copolymer precipitated is filtered off and dried.

(5) Molecular Weight of Copolymer (A)

From the viewpoint of ensuring good coating property, the weight-average molecular weight of the copolymer (A) is 2.01×10⁵ to 1.5×10⁶, preferably 2.1×10⁵ to 1.2×10⁶, more preferably 2.6×10⁵ to 1.0×10⁶. When the weight-average molecular weight of the copolymer is in the above range, a paste viscosity suitable for coating a base can be obtained, and on the other hand, a problem of stringing does not occur, so that the calcining paste composition exhibits good coating property. For measuring a molecular weight in the present invention, a method described in the later-described working examples is used.

(6) SP Value of Copolymer (A)

From the viewpoint that the solubility of the copolymer (A) in a wide range of solvents is ensured while the copolymer (A) has appropriate viscosity, it is preferable that the SP value of the copolymer (A) is 7 to 10, and it is more preferable that the SP value thereof is 8 to 10. The SP value of the copolymer is an indication of polarity of the polymer and is a measure to confirm solubility in a solvent used in the calcining paste composition. In the present invention, the SP value of the polymer and the SP value of the later-described solvent can be calculated from a constant of ΔF of Okitsu (Toshinao Okitsu, “Adhesion”, Vol. 40, No. 8, p. 342 (1996)).

(7) Constitution of Copolymer (A)

In the polymerization of a (meth)acrylicmonomer, the reactivity is 100%, and therefore, it is thought that the proportion of each monomer in the monomer mixture is equal to the proportion of a constituent unit derived from each monomer in the resulting copolymer.

(8) Reason for Selection of Each Monomer in Copolymer (A)

It is thought that the constituent unit derived from each monomer in the copolymer (A) exhibits properties by virtue of such an interrelationship as described below.

As previously described, if an acrylic resin is used in a calcining paste composition, polymer chains entangled by the interaction between the acryloyl groups exist in the calcining paste composition, and in the past, therefore, there was a problem of occurrence of stringing or the like during the coating process.

The substituent R² (excluding the case of a single bond or a straight-chain hydrocarbon group) in the constituent unit derived from the monomer (a-1), the substituent R⁵ in the constituent unit derived from the monomer (a-2), and the substituent R³ in the constituent unit derived from the monomer (a-1) in the case of a heterocyclic group are bulky groups, and therefore, they are thought to function as steric hindrance groups. It is thought that because of these steric hindrance groups, it becomes difficult for the (meth)acryloyl groups to come close to each other, so that the interaction does not take place. It is thought that polymer intra-chain entanglement and polymer inter-chain entanglement derived from the interaction between the (meth)acryloyl groups of the copolymer (A) are consequently inhibited, and stringing of the calcining paste composition containing this copolymer is inhibited.

However, if the polymer intra-chain entanglement and the polymer inter-chain entanglement in the copolymer (A) are inhibited by the presence of the steric hindrance groups, the viscosity of the calcining paste composition containing the copolymer (A) is lowered in excess, and when the calcining paste composition is applied to a base, there occurs a problem such that formation of a coating film becomes difficult.

On the other hand, lowering of a viscosity of the calcining paste composition is desirable in the coating process. The reason is that when the calcining paste composition is applied to a base by, for example, screen printing, the calcining paste composition is applied by rubbing the composition on a fine mesh with a squeegee, so that the calcining paste composition needs to completely pass through the mesh.

Accordingly, it is required that while having appropriate viscosity, the calcining paste composition exhibits appropriate fluidity (thixotropic property) in the coating process by giving a stress such as rubbing or stirring to the composition.

On that account, the substituent R³ of the monomer (a-1) has been introduced in order to impart thixotropic property to the calcining paste composition. Specifically, the substituent R³ is thought to form an intermolecular force, such as hydrogen bond, between the polymer chains of the copolymer (A). This intermolecular force allows the calcining paste composition to exhibit appropriate viscosity, and on the other hand, this force is weaker than a covalent bond, so that it is readily severed by the stress such as rubbing or stirring in the coating process. It is thought that while having appropriate viscosity, the calcining paste composition containing the copolymer (A) according to the present invention consequently exhibits fluidity by giving a stress to the composition through rubbing, stirring or the like, and exerts good coating property, that is, the composition exerts good thixotropic property.

2. Calcining Paste Composition

The calcining paste composition of the present invention includes the copolymer (A) as described above, preferably includes the solvent (B) and the inorganic powder (C), and more preferably further includes the dispersing agent (D).

(1) Amount of Copolymer (A)

The calcining paste composition of the present invention contains the copolymer (A) in an amount of 1 to 20% by mass, more preferably 4 to 10% by mass, based on 100% by mass of the calcining paste composition.

When the proportion of the copolymer (A) is in the above range, the copolymer (A) not only has good compatibility with the solvent (B) but also can impart appropriate viscosity to the calcining paste composition, and moreover, dispersibility of the inorganic powder (C) in the calcining paste composition and binding ability of the calcining paste composition to a base are also good.

(2) Solvent (B)

As the solvents (B), solvents leaving no residue after calcining and capable of dissolving the copolymer (A) can be used without any restriction. However, when a solvent satisfying a relationship of the following formula (III) together with the copolymer (A) is used as the solvent (B), compatibility of the copolymer (A) and the solvent (B) with each other is enhanced, and stability of the resulting calcining paste composition is increased, so that such a solvent is desirable.

|(SP value of the copolymer (A))−(SP value of the solvent (B))|<2 (III)

Examples of the solvents (B) include organic solvents, such as terpineol, dihydroterpineol, dihydroterpinyl acetate, butyl carbitol acetate, dipropylene glycol, dipropylene glycol monomethyl ether, butyl carbitol, diethylene glycol alkyl ether acetate (here, alkyl is, for example, n-butyl, propyl or ethyl; the same shall apply hereinafter), ethylene glycol alkyl ether acetate, ethylene glycol diacetate, diethylene glycol alkyl ether, ethylene glycol alkyl ether, dipropylene glycol alkyl ether, propylene glycol alkyl ether acetate, 2,2,4-trimethylpentane-1,3-diol monoisobutyrate, 2,2,4-trimethylpentane-1,3-diol diisobutyrate and 2,2,4-trimethylpentane-1,3-diol diisobutyrate. These solvents can be used singly or as a mixture of two or more kinds. From the viewpoints of boiling point of the solvent and leveling property, more preferred solvents are terpineol, dihydroterpineol, dihydroterpinyl acetate and butyl carbitol acetate.

The boiling point of the solvent (B) is preferably 150 to 300° C., more preferably 200 to 290° C., much more preferably 220 to 280° C. When the boiling point is within the above range, there is no fear that the drying rate of the paste after screen printing may be increased, and the drying rate is not decreased to lower workability.

The calcining paste composition of the present invention contains the solvent (B) in an amount of 20 to 70% by mass, preferably 30 to 60% by mass, based on 100% by mass of the calcining paste composition.

When the proportion of the solvent (B) is in the above range, the solvent (B) has good compatibility with the copolymer (A), and besides, the resulting paste can exhibit desired viscosity.

(3) Inorganic Powder (C)

Examples of the inorganic powders (C) include metal powders, metal oxide powders, glass powders, pigment powders, fluorescent substance powders, ceramic powders, and powders obtained by imparting photosensitivity to these powders. These inorganic powders are selected according to the use purpose, and these inorganic powders can be each used singly or as a mixture of two or more kinds. The metal powders and the metal oxide powders are preferably used as conductive powders, and the glass powders and the ceramic powders are preferably used as dielectric powders.

Examples of the metal powders include powders made of nickel, palladium, platinum, gold, silver, copper, iron, aluminum, tungsten and alloys of these metals.

Examples of the metal oxide powders include powders of ITO, antimony-doped tin oxide (ATO) and fluorine-doped tin oxide (FTO).

Examples of the glass powders include powders of bismuth oxide glass, silicate glass, lead glass, zinc glass and boron glass, and glass powders of various silicon oxides.

Examples of the ceramic powders include powders of alumina, zirconia, titanium oxide, barium titanate, alumina nitride, silicon nitride and boron nitride.

The calcining paste composition of the present invention contains the inorganic powders (C) in an amount of 20 to 70% by mass, preferably 35 to 60% by mass, based on 100% by mass of the calcining paste composition.

When the proportion of the inorganic powder (C) is in the above range, properties of a calcined body obtained from the calcining paste composition, such as conductivity, are good, and besides, dispersibility of the inorganic powder in the calcining paste composition is also good.

(4) Dispersing Agent (D)

Examples of the dispersing agents (D) include cationic dispersing agents, anionic dispersing agents, nonionic dispersing agents, amphoteric surface active agents and polymer-based dispersing agents. These dispersing agents can be each used singly or as a mixture of two or more kinds.

Examples of the cationic dispersing agents include polyamine-based dispersing agents.

Examples of the anionic dispersing agents include carboxylic acid-based, phosphoric acid ester-based, sulfuric acid ester-based, and sulfonic acid ester-based dispersing agents.

Examples of the nonionic dispersing agents include polyethylene glycol-based dispersing agents.

Examples of the amphoteric surface active agents include surface active agents having carboxylic acids and quaternary ammonium salts.

Examples of the polymer-based dispersing agents include poly (vinylpyrrolidone) and poly (vinyl alcohol).

If the dispersing agent (D) is used, the calcining paste composition of the present invention contains the dispersing agent (D) in an amount of 0.01 to 5% by mass, preferably 0.1 to 3% by mass, based on 100% by mass of the calcining paste composition.

When the proportion of the dispersing agent (D) is in the above range, dispersibility of the inorganic powder (C) in the calcining paste composition becomes better.

(5) Other Components

The calcining paste composition of the present invention may contain hitherto known plasticizer, wetting agent, anti-foaming agent and others, within limits not detrimental to the object of the present invention, in addition to the aforesaid components.

(6) Production Process for Calcining Paste Composition

Since the calcining paste composition of the present invention has viscosity as described later, it is preferable to produce the calcining paste composition by kneading the aforesaid components in one or several stages using a mixer, a roll, etc. singly or in appropriate combination. If necessary, heating at 30 to 150° C. may be carried out.

(7) Viscosity of Calcining Paste Composition

The viscosity of the calcining paste composition of the present invention at 25° C. is preferably 20 to 400 Pa·s, more preferably 100 to 300 Pa·s. When the viscosity is in the above range, the calcining paste composition is excellent not only in coating property but also in coating film-forming property. The viscosity is measured by the method described in the later-described working examples. The above viscosity is a value measured after the calcining paste composition is kneaded into a homogeneous state.

To take, as an example, a paste composition obtained by kneading a composition consisting of the copolymer (A), dihydroterpineol as the component (B) and a nickel filler having a mean particle diameter of 200 nm as the component (C) (blending ratio by mass: 4.5/39.5/56) by a revolving/rotating mixer and then further kneading the kneadate by a three-roll mill, the viscosity at 25° C. is preferably in the range of 20 to 400 Pa·s, more preferably in the range of 100 to 300 Pa·s.

3. Production Process for Calcined Body and Calcined Body Obtained by the Production Process

The production process for a calcined body using the calcining paste composition comprises:

a step of applying the calcining paste composition to a base (also referred to as an “application step” hereinafter),

a step of drying the applied calcining paste composition (also referred to as a “drying step” hereinafter), and

a step of calcining a laminate of the dried calcining paste composition and the base (also referred to as a “calcining step” hereinafter).

Examples of the bases in the application step include members of metal, ceramic, green sheet, plastic, semiconductor, etc.

Examples of coating methods in the application step include coating methods using screen printing, die coating, doctor blade printing, roll coating, offset printing, gravure printing, flexographic printing, inkjet printing, dispenser printing and the like, and a casting method for forming a sheet. Preferable is screen printing.

In the drying step, drying of the solvent (B) is carried out.

In order to thermally decompose the copolymer (A), the calcining step is carried out in a stream of an inert gas such as nitrogen gas usually at 500 to 1,000° C. for 1 to 5 hours.

Through the above production process, a calcined body is obtained.

4. Uses of Calcining Paste Composition

Specific examples of uses of the calcining paste composition of the present invention include a conductive paste, a dielectric paste and a fluorescent substance paste. These are not only used in the form of pastes but also used in the form of green sheets. Here, the green sheet means an uncalcined body in a sheet form obtained by applying a paste composition to a base.

The conductive paste is used as a material for forming electrodes such as internal electrodes and terminal electrodes in the production of MLCC and low temperature co-fired ceramics (LTCC), and in addition, it is used as a material for forming electrodes in the production of touch panels, PDP, LCD and LED or as a material for forming circuits in the production of solar panel drive units.

The dielectric paste is used as a material for forming dielectric layers in the production of MLCC, LTCC and PDP, and in addition, it is used as a material for forming barrier materials in the production of PDP or as a sealing material in the production of field emission displays (FED) and IC packages.

The fluorescent substance paste is used as a material for forming fluorescent substances in the production of PDP, FED and EL elements.

On the other hand, the calcining paste composition of the present invention has good thixotropic property, and therefore, it can be used to be applied using, for example, screen printing, die coating, doctor blade printing, roll coating, off set printing, gravure printing, flexographic printing, inkjet printing or dispenser printing. The calcining paste composition is preferably used for the screen printing among them, and can preferably carry out pattern formation.

Accordingly, it is preferable to use the calcining paste composition of the present invention as a material for forming electrodes such as internal electrodes in which formation of a pattern is required, among the above examples of uses. It is also preferable to use a laminate of the calcining paste composition and a green sheet, said laminate being obtained by printing the calcining paste composition on a green sheet containing the calcining paste composition of the present invention or a green sheet containing a paste composition other than the calcining paste composition of the present invention.

Using the calcining paste composition of the present invention, MLCC can be produced by, for example, the following method. The calcining paste composition of the present invention using a ceramic powder as the inorganic powder (C) is applied to a base by, for example, a casting method to mold the composition into a sheet, whereby a green sheet is obtained. On this green sheet, the calcining paste composition of the present invention using a conductive powder as the inorganic powder (C) is printed by, for example, screen printing to form an internal electrode pattern and then dried to obtain a laminate of the internal electrode pattern and the green sheet.

Subsequently, a plurality of the laminates, each consisting of the internal electrode pattern and the green sheet, are laminated in such a manner that the internal electrode patterns are alternately drawn out on the reverse end sides, whereby an uncalcined laminate is obtained.

This laminate is calcined in an atmosphere of an inert gas such as N₂ to obtain a ceramic laminate (multi-layer ceramic element) that is a calcined body. On the both end surfaces of the resulting ceramic laminate, external electrodes are formed, whereby MLCC is obtained.

### EXAMPLES

The present invention is further described with reference to the following examples, but it should be construed that the present invention is in no way limited to those examples.

The measurement conditions for the values in the examples are as follows.

In the description of the measurement conditions, the “(co)polymer” indicates any one of copolymers 1 to 9 produced in Preparation Examples 1 to 9 and ethyl cellulose, and the “calcining paste composition” indicates any one of calcining paste compositions produced in Examples 1 to 6 and Comparative Examples 1 to 4.

<Weight—Average Molecular Weight (Mw)>

Analysis by gel permeation chromatography was carried out, and a weight-average molecular weight in terms of polystyrene was calculated.

Apparatus: GPC-8220 (manufactured by Tosoh Corporation)

Column: one of G7000HXL/7.8 mmID+two of GMHXL/7.8 mmID+one of G2500HXL/7.8 mmID

Medium: tetrahydrofuran

Flow rate: 1.0 mL/min

Concentration: 1.5 mg/mL

Injection quantity: 300 μL

Column temperature: 40° C.

<SP Value>

SP value was calculated from a constant of ΔF of Okitsu (Toshinao Okitsu, “Adhesion”, Vol. 40, No. 8, P. 342 (1996)).

<Printability>

The calcining paste composition was applied to a glass plate by screen printing under the conditions of 640 meshes, a gap of 0.1 mm and a rate of 30 cm/sec and dried, and surface roughness (Ra) was measured by a surface roughness meter. Using the resulting surface roughness value as an indication, printability was evaluated in accordance with the following criteria.

AA: Ra is not more than 0.15.

BB: Ra is more than 0.15 but not more than 0.2.

CC: Ra is more than 0.2 but not more than 0.25.

DD: Ra is more than 0.25.

<Viscosity>

Viscosity of the calcining paste composition was measured by an E type viscometer at 25° C., and the viscosity was evaluated in accordance with the following criteria.

AA: Viscosity is not less than 100 Pa·s.

BB: Viscosity is not less than 20 Pa·s but less than 100 Pa·s.

CC: Viscosity is not less than 5 Pa·s but less than 20 Pa·s.

DD: Viscosity is less than 5 Pa·s.

<Compatibility Stability>

Whether phase separation of the calcining paste composition having been prepared occurred or not was visually confirmed, and compatibility stability was evaluated in accordance with the following criteria.

AA: Separation of the paste composition did not occur for a period of not less than 72 hours.

BB: Separation of the paste composition occurred within a period of more than 24 hours but less than 72 hours.

CC: Separation of the paste composition occurred within a period of 24 hours.

<Calcining Property>

After the (co)polymer was subjected to calcining (TG-DTA) in a nitrogen atmosphere at 700° C. for 1 hour, presence or absence of residual carbon was visually confirmed in accordance with the following criteria, and calcining property of the (co)polymer was evaluated in accordance with the following criteria.

AA: There is no residual carbon.

BB: There is a slight amount of residual carbon.

CC: There is a non-negligible amount of residual carbon.

### Preparation Example 1

In a flask equipped with a stirring device, a nitrogen gas feed pipe, a thermometer and a reflux condenser tube, 30 parts by mass of ethyl acetate and 100 parts by mass of a monomer mixture consisting of 30 parts by mass of 4-methacryloyloxy-2,2,6,6-tetramethylpiperidine and 70 parts by mass of tert-butyl methacrylate were placed, and while feeding nitrogen gas to the flask, stirring was carried out for 30 minutes to purge the flask with nitrogen. Thereafter, the contents of the flask were heated up to 80° C. Subsequently, while maintaining the contents of the flask at 80° C., 0.02 part by mass of azobisisobutyronitrile was added five times at hourly intervals. After the reaction was carried out at 80° C. for 8 hours, 1 part by mass of azobisisobutyronitrile and 200 parts by mass of ethyl acetate were dropwise added over a period of 4 hours, then the reaction was further carried out at 80° C. for 4 hours, and thereafter, the contents of the flask were cooled down to room temperature. The resulting copolymer solution was dropwise added to 2000 parts by mass of n-hexane over a period of 30 minutes to form a copolymer precipitate. The copolymer precipitate was filtered off through a 200-mesh wire cloth and dried at 105° C. for 8 hours to prepare a copolymer 1. The resulting copolymer 1 had a weight-average molecular weight of 800,000 and a SP value of 8.3 as a calculated value.

### Preparation Example 2

A copolymer 2 was prepared in the same manner as in Preparation Example 1, except that the monomer mixture was changed to a monomer mixture consisting of 30 parts by mass of tetrahydrofurfuryl methacrylate and 70 parts by mass of tert-butyl methacrylate. The resulting copolymer 2 had a weight-average molecular weight of 500,000 and a SP value of 8.4 as a calculated value.

### Preparation Example 3

A copolymer 3 was prepared in the same manner as in Preparation Example 1, except that the monomer mixture was changed to a monomer mixture consisting of 30 parts by mass of 2-hydroxyisobutyl methacrylate and 70 parts by mass of isobutyl methacrylate. The resulting copolymer 3 had a weight-average molecular weight of 800,000 and a SP value of 8.9 as a calculated value.

### Preparation Example 4

A copolymer 4 was prepared in the same manner as in Preparation Example 1, except that the monomer mixture was changed to a monomer mixture consisting of 30 parts by mass of 2,2-dimethyl-3-hydroxypropyl methacrylate and 70 parts by mass of isobutyl methacrylate. The resulting copolymer 4 had a weight-average molecular weight of 700,000 and a SP value of 8.8 as a calculated value.

### Preparation Example 5

A copolymer 5 was prepared in the same manner as in Preparation Example 1, except that the monomer mixture was changed to a monomer mixture consisting of 30 parts by mass of 2-methacryloyloxyethylhexahydrophthalic acid and 70 parts by mass of isobornyl methacrylate. The resulting copolymer 5 had a weight-average molecular weight of 600,000 and a SP value of 9.1 as a calculated value.

### Preparation Example 6

A copolymer 6 was prepared in the same manner as in Preparation Example 1, except that the monomer mixture was changed to a monomer mixture consisting of 30 parts by mass of methacrylic acid [(3,4-epoxycyclohexan)-1-yl]methyl and 70 parts by mass of isobutyl methacrylate. The resulting copolymer 6 had a weight-average molecular weight of 400,000 and a SP value of 8.8 as a calculated value.

### Preparation Example 7

A copolymer 7 was prepared in the same manner as in Preparation Example 1, except that the monomer mixture was changed to a monomer mixture consisting of 5 parts by mass of 2,2-dimethyl-3-hydroxypropyl methacrylate and 95 parts by mass of isobutyl methacrylate. The resulting copolymer 7 had a weight-average molecular weight of 800,000 and a SP value of 8.7 as a calculated value.

### Preparation Example 8

In a flask equipped with a stirring device, a nitrogen gas feed pipe, a thermometer and a reflux condenser tube, 100 parts by mass of methyl ethyl ketone were placed, and while feeding nitrogen gas to the flask, stirring was carried out for 30 minutes to purge the flask with nitrogen. Thereafter, the contents of the flask were heated up to 80° C. Subsequently, while maintaining the contents of the flask at 80° C., 100 parts by mass of a monomer mixture consisting of 30 parts by mass of 2-hydroxyisobutyl methacrylate and 70 parts by mass of isobutyl methacrylate were dropwise added over a period of 2 hours. Simultaneously with the beginning of the dropwise addition, 0.4 part by mass of azobisisobutyronitrile was added five times at hourly intervals. From the beginning of the dropwise addition, the reaction was carried out at 80° C. for 8 hours, and thereafter, the contents of the flask were cooled down to room temperature. The resulting copolymer solution was dropwise added to 2000 parts by mass of n-hexane over a period of 30 minutes to form a copolymer precipitate. The copolymer precipitate was filtered off through a 200-mesh wire cloth and dried at 105° C. for 8 hours to prepare a copolymer 8. The resulting copolymer 8 had a weight-average molecular weight of 150,000 and a SP value of 8.9 as a calculated value.

### Preparation Example 9

A copolymer 9 was prepared in the same manner as in Preparation Example 1, except that the monomer mixture was changed to a monomer mixture consisting of 30 parts by mass of 2-hydroxyisobutyl methacrylate and 70 parts by mass of methyl methacrylate. The resulting copolymer 9 had a weight-average molecular weight of 500,000 and a SP value of 10.8 as a calculated value.

### Example 1

A composition (total amount of the composition: 100% by mass) containing 4.5% by mass of the copolymer 1, 56% by mass of a Ni filler (mean particle diameter: 200 nm) and 39.5% by mass of dihydroterpineol (SP value: 8.8, boiling point: 247° C.) was kneaded by a revolving/rotating mixer (trade name: “Awatori Rentaro”, manufactured by THINKY Corporation) and then further kneaded by a three-roll mill to obtain a calcining paste composition 1. Measurement results of properties of the calcining paste composition 1 are set forth in Table 2.

### Example 2

A calcining paste composition 2 was obtained in the same manner as in Example 1, except that the copolymer 2 was used instead of the copolymer 1. Measurement results of properties of the calcining paste composition 2 are set forth in Table 2.

### Example 3

A calcining paste composition 3 was obtained in the same manner as in Example 1, except that the copolymer 3 was used instead of the copolymer 1. Measurement results of properties of the calcining paste composition 3 are set forth in Table 2.

### Example 4

A calcining paste composition 4 was obtained in the same manner as in Example 1, except that the copolymer 4 was used instead of the copolymer 1. Measurement results of properties of the calcining paste composition 4 are set forth in Table 2.

### Example 5

A calcining paste composition 5 was obtained in the same manner as in Example 1, except that the copolymer 5 was used instead of the copolymer 1. Measurement results of properties of the calcining paste composition 5 are set forth in Table 2.

### Example 6

A calcining paste composition 6 was obtained in the same manner as in Example 1, except that the copolymer 6 was used instead of the copolymer 1. Measurement results of properties of the calcining paste composition 6 are set forth in Table 2.

### Comparative Example 1

A calcining paste composition 7 was obtained in the same manner as in Example 1, except that ethyl cellulose (available from Nisshin & Co., Ltd., product name: ETHOCEL grade 100, weight-average molecular weight: 140,000, SP value: 8.8) was used instead of the copolymer 1. Measurement results of properties of the calcining paste composition 7 are set forth in Table 1.

### Comparative Example 2

A calcining paste composition 8 was obtained in the same manner as in Example 1, except that the copolymer 7 was used instead of the copolymer 1. Measurement results of properties of the calcining paste composition 8 are set forth in Table 2.

### Comparative Example 3

A calcining paste composition 9 was obtained in the same manner as in Example 1, except that the copolymer 8 was used instead of the copolymer 1. Measurement results of properties of the calcining paste composition 9 are set forth in Table 2.

### Comparative Example 4

A calcining paste composition 10 was obtained in the same manner as in Example 1, except that the copolymer 9 was used instead of the copolymer 1. Measurement results of properties of the calcining paste composition 10 are set forth in Table 2.

TABLE 1

| | | | Copolymer | | | | | | | | |
|---|---|---|---|---|---|---|---|---|---|---|---|
| | | | Copoly- | Copoly- | Copoly- | Copoly- | Copoly- | Copoly- | Copoly- | Copoly- | Copoly- |
| | | | mer 1 | mer 2 | mer 3 | mer 4 | mer 5 | mer 6 | mer 7 | mer 8 | mer 9 |
| Monomer | Monomer | 2HBMA | | | 30 | | | | | 30 | 30 |
| mixture | (a-1) | HO-HH | | | | | 30 | | | | |
| | | FA-712HM | 30 | | | | | | | | |
| | | DMHPMA | | | | 30 | | | 5 | | |
| | | THFMA | | 30 | | | | | | | |
| | | EPCMA | | | | | | 30 | | | |
| | Monomer | CHMA | | | | | | | | | |
| | (a-2) | tBMA | 70 | 70 | | | | | | | |
| | | iBMA | | | 70 | 70 | | 70 | 95 | 70 | |
| | | IBXMA | | | | | 70 | | | | |
| | Monomer | MMA | | | | | | | | | 70 |
| | (a-3) | | | | | | | | | | |

Unit of each numerical value in the table is % by mass, and the total amount of the monomer mixture is 100% by mass.

TABLE 2

| | | | \| (SP value of | | | | | |
|---|---|---|---|---|---|---|---|---|
| | | | (co)polymer) − | Weight-average | | | | |
| | Type of | SP value of | (SP value of | molecular | | | Compatibility | Calcining |
| | (co)polymer | (co)polymer | solvent) \| | weight | Printability | Viscosity | stability | property |
| Ex. 1 | copolymer 1 | 8.3 | 0.5 | 800,000 | BB | BB | AA | BB |
| Ex. 2 | copolymer 2 | 8.4 | 0.4 | 500,000 | AA | CC | AA | AA |
| Ex. 3 | copolymer 3 | 8.9 | 0.1 | 800,000 | BB | BB | AA | AA |
| Ex. 4 | copolymer 4 | 8.8 | 0 | 700,000 | BB | AA | AA | AA |
| Ex. 5 | copolymer 5 | 9.1 | 0.3 | 600,000 | CC | AA | BB | BB |
| Ex. 6 | copolymer 6 | 8.8 | 0 | 400,000 | BB | CC | AA | AA |
| Comp. Ex. 1 | ethyl cellulose | 8.8 | 0 | 140,000 | AA | AA | AA | CC |
| Comp. Ex. 2 | copolymer 7 | 8.7 | 0.1 | 800,000 | DD | CC | AA | AA |
| Comp. Ex. 3 | copolymer 8 | 8.9 | 0.1 | 150,000 | AA | DD | AA | AA |
| Comp. Ex. 4 | copolymer 9 | 10.8 | 2 | 500,000 | DD | BB | CC | AA |

The abbreviations in Table 1 are as follows.

2HBMA: 2-hydroxyisobutyl methacrylate

HO—HH: 2-methacryloyloxyethylhexahydrophthalic acid

FA-712HM: 4-methacryloyloxy-2,2,6,6-tetramethylpiperidine

DMHPMA: 2,2-dimethyl-3-hydroxypropyl methacrylate

THFMA: tetrahydrofurfuryl methacrylate

EPCMA: methacrylic acid [(3,4-epoxycyclohexan)-1-yl]methyl

CHMA: cyclohexyl methacrylate

tBMA: tert-butyl methacrylate

iBMA: isobutyl methacrylate

IBXMA: isobornyl methacrylate

MMA: methyl methacrylate

The compounds used in the examples are as follows when represented in conformity with the formula (I).

TABLE 3

| | R² | R³ |
|---|---|---|
| 2HBMA | —CH₂—C(CH₃)₂— | —OH |
| HO-HH | 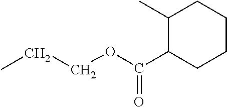 | —COOH |
| FA-712HM | single bond | 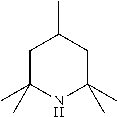 |
| DMHPMA | —CH₂—C(CH₃)₂—CH₂— | —OH |
| THFMA | —CH₂— | 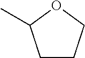 |
| EPCMA | —CH₂— | 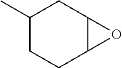 |

From Examples 1 to 6, it can be seen that the calcining paste compositions of the present invention have appropriate viscosity and good printability, the coated surfaces of the compositions are smooth because the compositions suffer no stringing, and further, the compositions have good calcining property and are stable. Specifically, it is thought that in the screen printing, printing is carried out by rubbing a calcining paste composition on a fine mesh with a squeegee, and therefore, a stress is applied to the calcining paste composition during the printing, and the calcining paste compositions of Examples 1 to 6 have good thixotropic property, so that while having appropriate initial viscosity, they exhibit viscosity lowered by the application of a stress during the printing, and they pass through the mesh completely and are printed with smooth surfaces.

When Examples 1 to 6 of the present invention are compared with Comparative Example 1, it can be seen that the calcining property of the calcining paste compositions of the present invention was better than that in the case where ethyl cellulose was used instead of the copolymer (A).

When Example 4 of the present invention is compared with Comparative Example 2, it can be seen that when the proportion of the monomer (a-1) in the monomer mixture was lower than the lower limit of the range of the present invention, the printability was not good, and evaluation of the viscosity was also lowered. The reason is thought to be that since the proportion of the monomer having R³ supposed to form an intermolecular force is low, the thixotropic property is not favorably exhibited.

When Examples 1 to 6 of the present invention are compared with Comparative Example 3, it can be seen that when the copolymer (A) has a lower molecular weight than the molecular weight range defined in the present invention, viscosity is not good.

When Examples 1 to 6 of the present invention are compared with Comparative Example 4, it can be seen that even though a monomer mixture containing no monomer (a-2) was copolymerized, the printability and the dispersing stability were not good. The reason is thought to be that if the monomer (a-2) is not contained, the proportion of a substituent functioning as a steric hindrance group is low and causes a problem of stringing, and besides, polarity of the copolymer is increased to thereby lower compatibility of the copolymer with the solvent.

1. A calcining paste composition comprising a copolymer (A) obtained by copolymerizing a monomer mixture containing a monomer (a-1) represented by the following general formula (I) in an amount of 10 to 80% by mass and a monomer (a-2) represented by the following general formula (II) in an amount of 20 to 90% by mass (with the proviso that the total amount of the monomer mixture is 100% by mass), said copolymer (A) having a weight-average molecular weight of 2.01×10⁵ to 1.5×10⁶, 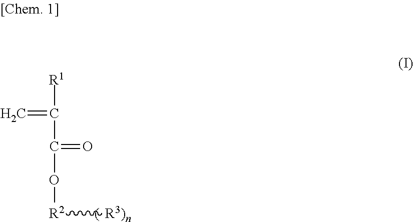
wherein R¹ represents a hydrogen atom or a methyl group, R² represents a branched hydrocarbon group, a straight-chain hydrocarbon group, a group having a cyclic structure or a single bond, R³ represents a group selected from the group consisting of a hydroxyl group, a carboxyl group, an amino group, an amide group, an acetoacetoxy group, an acid anhydride group, a sulfonic acid group, a phosphoric acid group, a thiol group and a heterocyclic group, n represents an integer of 1 to 6, when n is 2 or greater, R³s may be the same as or different from each other, when R² is a single bond or a straight-chain hydrocarbon group, R³ is a heterocyclic group, and R² and R³ are bonded to each other by one or two bonding hands, 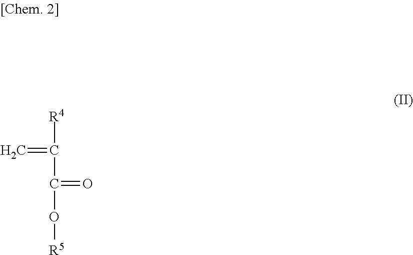
wherein R⁴ represents a hydrogen atom or a methyl group, and R⁵ represents a branched alkyl group or a group having a cyclic structure.

2. The calcining paste composition as claimed in claim 1, wherein an SP value of the copolymer (A) is 7 to 10.

3. The calcining paste composition as claimed in claim 1, comprising:
the copolymer (A),
a solvent (B), and
an inorganic powder (C).

4. The calcining paste composition as claimed in claim 3, wherein the copolymer (A) and the solvent (B) satisfy a relationship of the following formula (III):

|(SP value of the copolymer (A))−(SP value of the solvent (B))|<2 (III).

5. The calcining paste composition as claimed in claim 3, further comprising a dispersing agent (D).

6. The calcining paste composition as claimed in claim 5, containing the copolymer (A) in an amount of 1 to 20% by mass, containing the solvent (B) in an amount of 20 to 70% by mass, containing the inorganic powder (C) in an amount of 20 to 70% by mass and containing the dispersing agent (D) in an amount of 0.01 to 5% by mass, each amount being based on 100% by mass of the calcining paste composition.

7. The calcining paste composition as claimed in claim 1, being for screen printing.

8. A green sheet comprising the calcining paste composition as claimed in claim 3.

9. A laminate of the calcining paste composition as claimed in claim 3 and a green sheet.

10. A multi-layer ceramic condenser produced by using the calcining paste composition as claimed in claim 3.

11. A production process for a calcined body, comprising:
a step of applying the calcining paste composition as claimed in claim 1 to a base,
a step of drying the applied calcining paste composition, and
a step of calcining a laminate of the dried calcining paste composition and the base.

12. A calcined body obtained by the production process for a calcined body as claimed in claim 11.
